(19) United States
(12) Patent Application Publication
(10) Pub. No.: US 2008/0101474 A1
(43) Pub. Date: May 1, 2008

(54) OPTIMIZING THE STORAGE AND REDUCING THE COMPUTATION OF REFERENCE PICTURE LIST PROCESSING IN VIDEO DECODING

(76) Inventors: Yi-Jen Chiu, San Jose, CA (US); Mei-Chen Yeh, Goleta, CA (US)

Correspondence Address: INTEL CORPORATION;c/o INTELLEVATE, LLC, P.O. BOX 52050, MINNEAPOLIS, MN, 55402, US

(21) Appl. No.: 11/555,522

(22) Filed: Nov. 1, 2006

(51) Int. Cl. H04N 11/04; H04N 7/12

(52) U.S. Cl. 375/240.24; 375/240.26

(57) ABSTRACT

A method of decoding a slice of video data may include determining two slice reference lists that are associated with the slice of video data and finding a co-located picture that is associated with the slice of video data. The method may also include retrieving two co-located reference lists that are associated with the co-located picture. Two lowest lists for the slice of video data may be calculated by comparing pairs of the two slice reference lists and the two co-located reference lists.

### BACKGROUND

Implementations of the claimed invention generally may relate to schemes for decoding video data and, more particularly, to such schemes that involve transmission of macroblocks without accompanying motion information.

H.264, also known as advanced video codec (AVC) and MPEG-4 Part 10, is the latest ITU-T/ISO video compression standard to be widely pursued by industry. The H.264 standard has been prepared by the Joint Video Team (JVT), which consisted of ITU-T SG16 Q.6, known as VCEG (Video Coding Expert Group), and of ISO/IEC JTC1/SC29/WG11, known as MPEG (Motion Picture Expert Group). H.264 is designed for the applications in the area of Digital TV broadcast (DTV), Direct broadcast satellite (DBS) video, Digital subscriber line (DSL) video, interactive storage media (ISM), multimedia messaging (MMM), Digital terrestrial TV broadcast (DTTB), remote video surveillance (RVS).

FIG. 1 illustrates a typical flow 100 of H.264 video coding, which includes a source 110 of video data, an H.264 encoder 120 to encode the video data, an H.264 decoder 130 to decode the encoded video data, and a display device 140 to display the decoded video data. Although not explicitly shown, it will be understood that the encoded video data may be transmitted (e.g., via the Internet or another communication system) and/or stored on a more permanent medium, such as an optical disc, magnetic storage device, etc.

H.264 is a block-based coding technique that utilizes the transform coding and entropy coding on the residue of the motion compensated block. In H.264, a macroblock (MB) consists of 16×16 luma pixels. An MB can further be partitioned into 16×8, 8×16, and 8×8. Each 8×8 block, called a sub-macroblock (SubMB) can be further divided into 8×4, 4×8, and 4×4 pieces.

FIG. 2 conceptually illustrates the concepts of reference lists within H.264 video coding. H.264 allows users to use the motion compensation prediction from the reference pictures in two reference lists, RefList0 (for P frames) and RefList1 (for B frames). Each of RefList0 and RefList1 may refer to up to 16 pictures and are sent with the encoded video data. The minimum unit to apply motion compensation referred by different pictures, is a SubMB (i.e., an 8×8 block). The reference pictures to be used for all of the SubMBs (e.g., SubMB 220) inside a slice 210 are placed in two reference picture lists, RefList0 230 and RefList1 240. The reference pictures in lists 230/240 are accessed via an index, called refldx, that reflects the order of reference pictures. RefldxL0 is the reference index pointing to RefList0 230, and refldxL1 is the reference index pointing to RefList1 240. An H.264 video decoder needs to decode the reference index for every SubMB to retrieve the information of the associated reference picture.

One of the desirable features of H.264 is the good coding efficiency accomplished by the application of many coding tools. One such tool, utilizing a direct/skipped mode for B-slice (i.e., bidirectional slice) pictures, can improve the coding efficiency by exploiting the temporal correlation that may exist between pictures. The direct/skipped mode does not transmit any motion information and reference picture indices to indicate the temporal correlation. Instead, the direct/skipped mode utilizes the motion information of the already decoded co-located MB in the reference pictures to efficiently represent the block motion without having to transmit any motion information of the current macroblock.

Because no motion information and reference picture indices are sent for the direct/skipped mode of a B-Slice picture, an H.264 video decoder in such a mode reconstructs the reference indices, refIdxL0 and refIdxL1, by deriving the reference indices from the co-located SubMB, called refldxCol, in the reference picture. The H.264 standard spec includes a process, called MapColToList0( ), to obtain the refIdxL0 (i.e., reference index for RefList0) for a MB in the temporal direct mode of a B-slice picture. Since H.264 allows video encoder to perform the list reordering at every slice, the order of pictures in the reference picture list (e.g., RefList0) may change as often as each slice, and a reference picture may appear at more than one index to the reference picture lists RefList0 or RefList1. Thus, the process of MapColToList0( ) requires a decoder to look for the lowest-valued reference index in the current reference list RefList0_current that is equal to the refldxCol.

The cost to implement the process of MapColToList0( ) could be very costly without proper architecture.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 conceptually illustrates a typical flow of H.264 video coding;

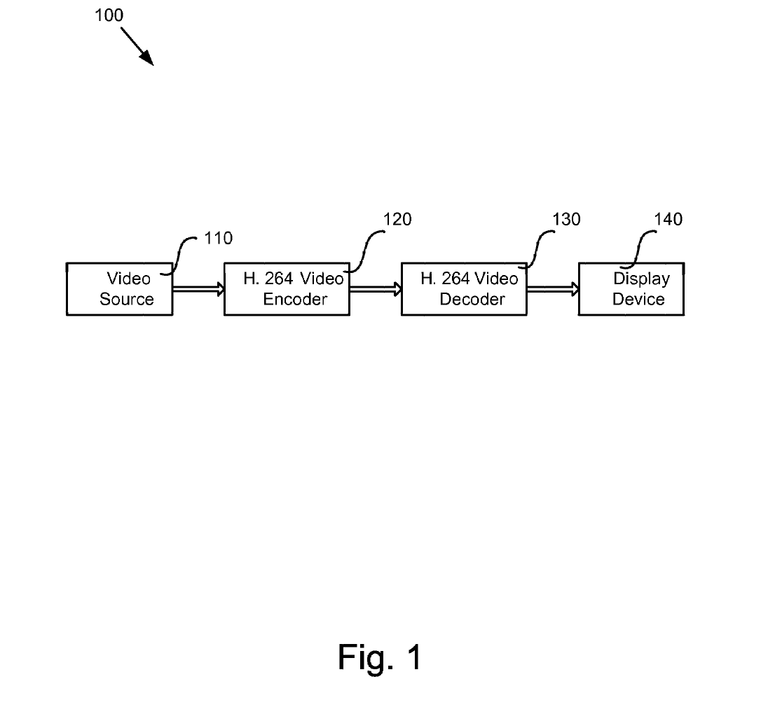

FIG. 2 conceptually illustrates the concepts of reference lists within H.264 video coding;

FIG. 3 illustrates an exemplary data format of the list parameters for a macroblock;

FIG. 4 illustrates a process to obtain the reference index for RefList0 for a slice of a picture;

FIG. 5 conceptually illustrates portions of the process of FIG. 4; and

FIG. 6 illustrates portions of the process of FIG. 4 in greater detail.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

The scheme described herein describes an efficient architecture to minimize the storage requirement and to reduce the computational complexity for the processing of reference picture lists (e.g., RefList0, RefList1) for the direct/skip mode of H.264 video decoder. First, the list parameters to be stored at the slice level, MB level, and SubMB level will be described. Second, the associated operations to be performed at the slice level to accomplish the task of MapColToList0( ) will be described. Third, the associated operations to be performed at the MB level to accomplish the task of MapColToList0( ) will be described.

### Parameter Storage:

At the slice level (e.g., information stored per slice), two reference lists may be maintained, RefList0 and RefList1. Each of these reference lists may refer to a particular slice, “slice_k” in the following explanation. Thus, the notations RefList0[slice_k] and RefList1 [slice_k] may indicate the RefList0 and RefList1 of the k-th slice of the picture for an H.264 video bitstream, because such bitstreams may contain more than one slice in a picture. It should be noted that the number of slices per picture is equal to 1 in the Main/High profiles of H.264.

At the MB level one parameter, slice_num, may be maintained. This parameter may indicate the slice number with which the MB is associated. For those pictures that only contain one slice, slice_num may equal 1 for all MBs in such pictures. In some implementations, slice_num may be initialized to 1, and may be changed from this value for those pictures containing more than one slice.

At the SubMB level, two parameters may be maintained: refldx and from_List0. The refIdx parameter may be an index into one of the per-slice reference lists, either RefList0 or RefList1. The from_list0 parameter may be, for example, a 1-bit information flag to indicate which of the reference lists (e.g., RefList0 or RefList1) the associated SubMB parameter refIdx is pointing to. For example, if from_List0=1, refldx may be pointing to RefList0, and if from_List0=0, refldx may be pointing to RefList1. Several of these parameters will be illustrated with regard to an exemplary MB.

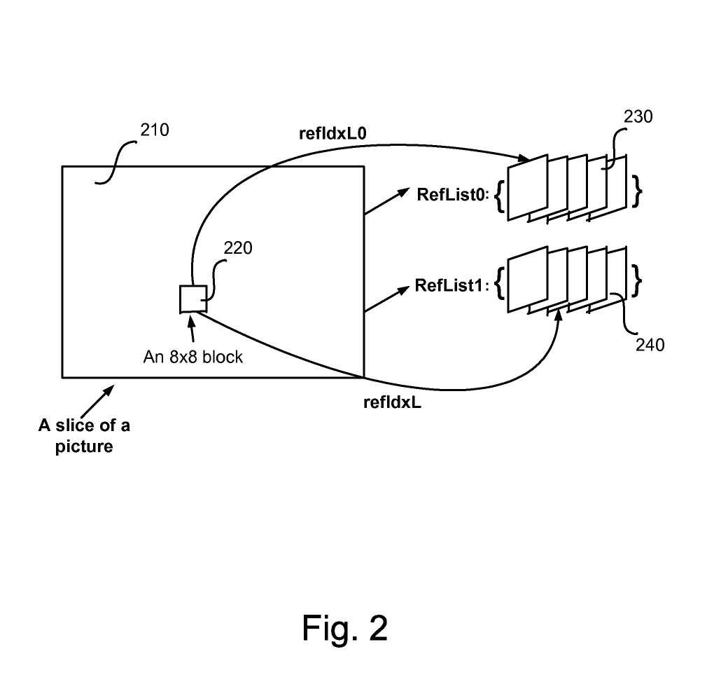

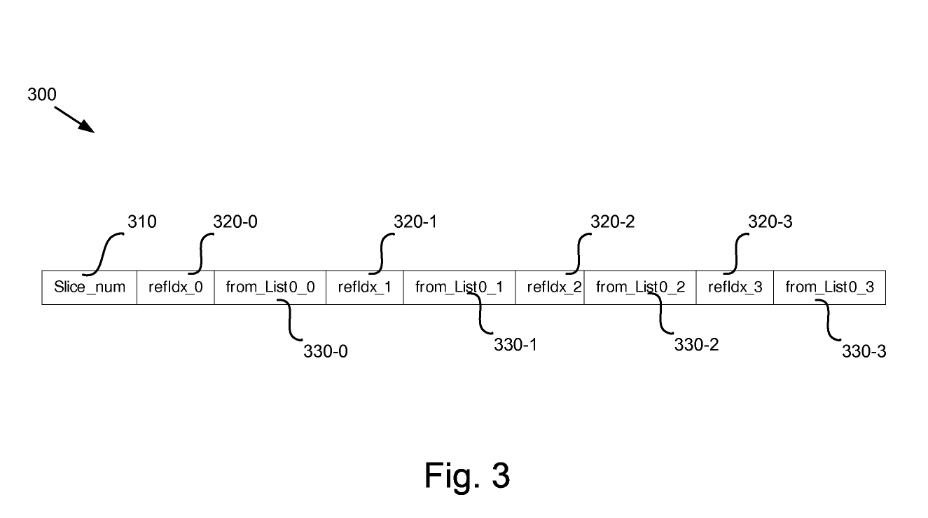

FIG. 3 illustrates a data format 300 of the list parameters for a macroblock (e.g., MB 220 in FIG. 2). Data format 300 may include slice_num 310, refIdx_0 320-0 to refIdx_3 320-3 (collectively reference indices refIdx_k parameters 320), and from_list_0_0 330-0 to from_list_0_3 330-3 (collectively from_list_0_k parameters 330). As explained above, slice_num 310 may indicate which slice number in a picture the MB of data format 300 is associated with. Because an MB includes 4 SubMBs, the refIdx_k parameters 320 and from_List0_k parameters are the refIdx and the from_List0 values associated with the four SubMBs (e.g., numbered 0 to 3) inside the MB.

As one particular example, from_list_0_0 330-0 specifies for the first sub-macroblock, SubMB_0, which one of the slice's reference lists (e.g., RefList0 or RefList1) are indexed for that particular SubMB. Also, refIdx_0 320-0 provides the index values into particular reference pictures in the specified reference list (e.g., RefList0 or RefList1) for SubMB_0.

### Slice Level Processing:

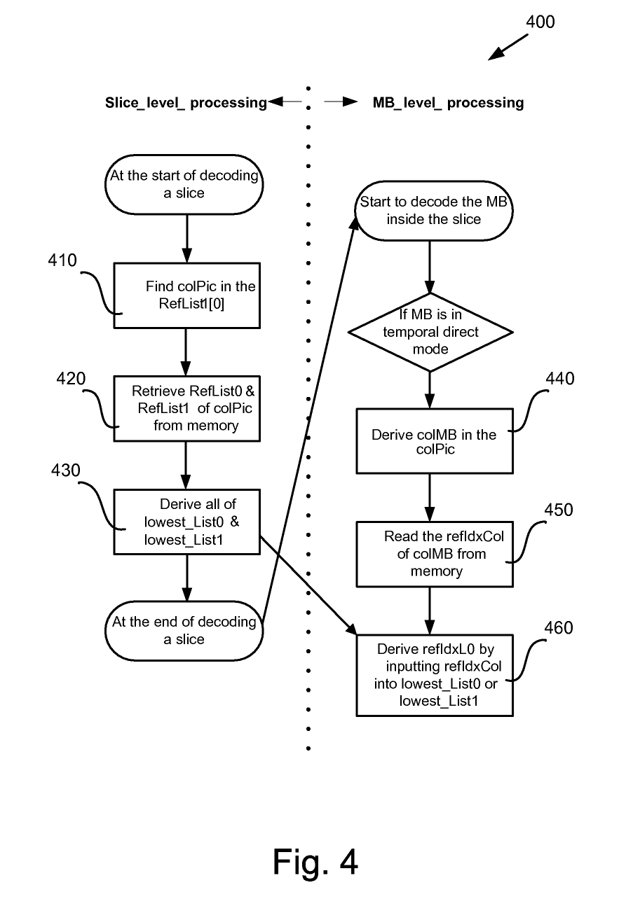

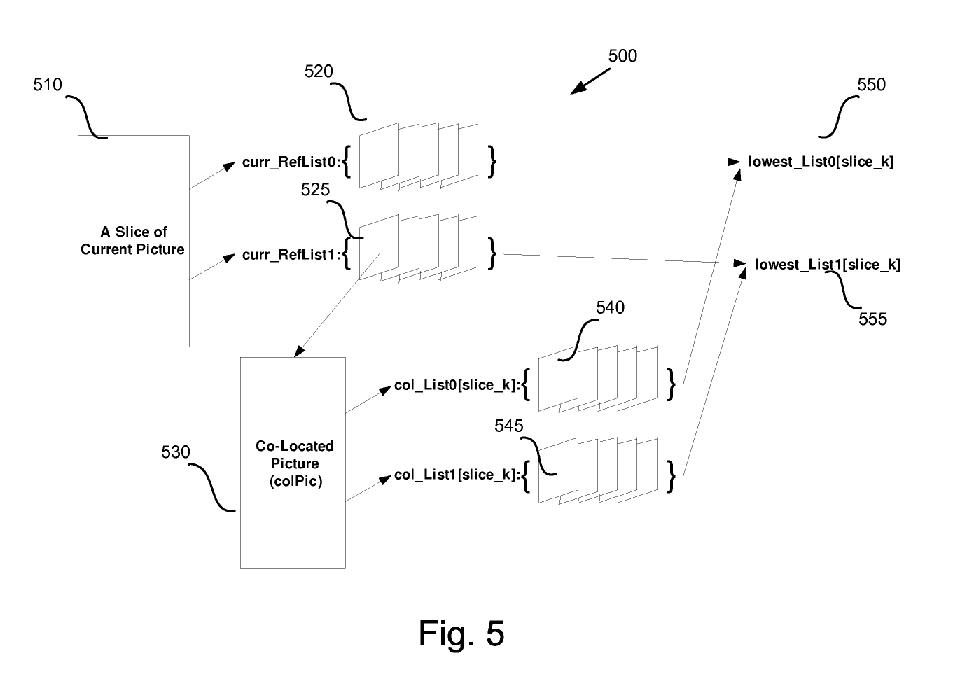

FIG. 4 illustrates a process 400 to obtain the refIdxL0 (i.e., the reference index for RefList0) for the purpose of MapColToList0( ). The slice-level portion of process 400 is shown on the left hand side of FIG. 4 (e.g., acts 410-430), and the MB-level portion of process 400 is shown on the right hand side of FIG. 4 (e.g., acts 440-460). To aid in understanding process 400 in FIG. 4, a visual representation 500 of portions of this process is shown in FIG. 5. Thus FIG. 5 may be referred to during the discussion of FIG. 4, and vice versa.

At the start of decoding a slice 510 the co-located picture (colPic) 530 may be found for use in the skip/direct mode [act 410]. The H.264 standard specifies that colPic 530 is located at the first picture in the RefList1 525 (i.e., RefList1[0]).

Process 400 may continue with the retrieval of RefList0 and RefList1 associated with colPic 530 (i.e., shown as col_List0[slice_k] 540 and col_List1[slice_k] 545) from a storage memory [act 420].

Process 400 may continue at the slice level by formulating the arrays lowest_List0[slice_k] 550 and lowest_List1[slice_k] 555 based on the information of col_List0[slice_k] 540, col_List1[slice_k] 545, and the RefList0 of current picture, denoted as curr_RefList0 520 [act 430]. Lowest_List0[slice_k] 550 and lowest_List1[slice_k] 555 may be calculated in act 430 so that subsequent per-MB calculation of refIdxL0 will only involve a small number of memory accesses, rather than extensive per-MB computations. Lowest_List0[slice_k] 550 may be calculated as follows. For the k-th slice of col_List0, the j-th component of lowest_List0[slice_k] is:

$$lowest\_List0 [ slice\_k ] [ j ] = {min}_{i} \{ curr\_RefList0 [ i ] = col\_List0 [ slice\_k ] [ j ] \}$$

### Similarly, for lowest_List1[slice_k] 555, for the k-th slice of col_List1, the j-th component lowest_List1[slice_k] is:

$$lowest\_List1 [ slice\_k ] [ j ] = {min}_{i} \{ curr\_RefList0 [ i ] = col\_List1 [ slice\_k ] [ j ] \}$$

Alternatively, act 430 may use the following pseudo code to produce lowest_List0[slice_k] 550:

```
Given slice number slice_k
for (j=0; j < ListSize; j++)
  {Initialize lowest_List0[slice_k][i]
  for (i=0; i < ListSize; i++)
    {if (curr_RefList0(i)) == col_List0[slice_k](j))
      {lowest_List0[slice_k][j] = i;
      break;}}}
```

The lowest_list1[slice_k] 555 may be produced by replacing List0 by List1 in the pseudo code. It should be noted that the ListSize, the size of the reference list in the above code, is equal to 32 and the number of slices may be up to 8. Hence, the size of all of lowest_List0 array will be equal to 8*32, and the lowest_List1 may be the same size as lowest_List0.

As may be seen from FIG. 5, lowest_list0[slice_k] 550 and lowest_list1[slice_k] 555 relate the minimum entry in the current reference lists (e.g., curr_RefList0 or curr_RefList1) that have the same value as a corresponding entry in the reference lists associated with colPic 530 (e.g., col_List0[slice_k] 540 or col_List1[slice_k] 545). These lowest_list arrays, calculated once per slice, simplify the MB level processing described below. Because the number of MB in a picture is large compared to the number of slices, this reduction of MB level processing may lead to a huge computational savings for a given picture. Also, the scheme described in FIG. 4 homogenizes the MB-level and slice-level operations which makes it easier to implement in various software/hardware platforms.

### MB Level Processing:

With the completion of lowest_List production at the slice level, process 400 may begin the decoding process for every MB inside the slice for which Lowest_List0[slice_k] 550 and Lowest_List1 [slice_k] 555 were determined. If the target MB is determined to be in the temporal direct mode, the co-located MB, colMB, may be determined from colPic 530 [act 440]. The scheme for locating the colMB is well documented in the H.264 video standard, and will not be further described here. Conversely, if the target MB is determined to be in the temporal direct mode, acts 440-460 may not be performed.

With the identification of colMB, processing may continue with retrieval of the previously stored MB-level parameter of refIdx_n (n=0,1,2,3), from_List0_n (n=0,1,2,3) and slice_num for all of the four SubMBs inside the colMB [act 450]. In act 450 in FIG. 4, the notation of “refIdxCol” is used to represent the co-located refldx stored on the colMB.

The reference index refIdxL0 for every SubMB may be read out of memory by, for example, a table look up from the j-th component (where j=the retrieved refIdx_n value) from the either the array of lowest_List0[slice_k] or lowest_List1[slice_k] [act 460]. Act 460 may use the lowest_List0[slice_k] array if the retrieved from_List0_n=1 for the SubMB in question. Act 460 may use the lowest_List1[slice_k] array if the retrieved from_List0_n=1 for the SubMB in question. As before, “slice_k” in the above notation denotes the retrieved slice_num.

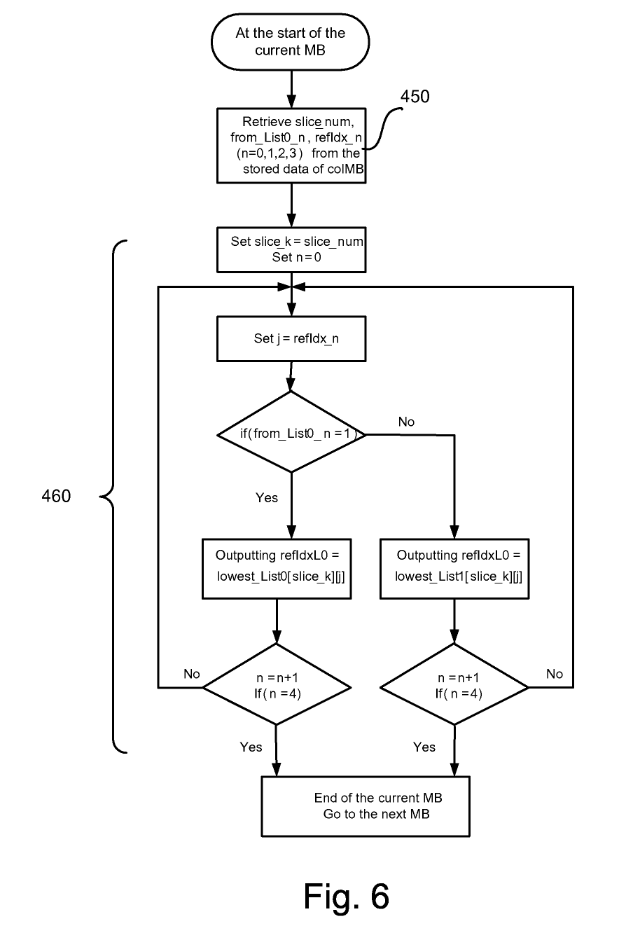

FIG. 6 illustrates portions of the process of FIG. 4 in greater detail. In particular, act 450 in FIG. 6 explicitly shows receipt of slice_num, from_list0_n, and refIdx_n (n=0, 1, 2, 3) from each of the four SubMBs in the stored colMB. Act 460 in FIG. 6 shows the decision, based on the value of from_list0_n for a particular SubMB_n, of looking up the value of refIdxL0 in either lowest_List0[slice_k] or lowest_List1 [slice_k]. The index into one or the other of these lists is provided by the value of refIdx_n for each SubMB_n.

Although not explicitly shown in FIGS. 4 and 6, once refIdxL0 has been found for all SubMBs in a MB, decoding of the slice and/or picture may continue in the temporal direct and/or skip mode using the current reference lists for the slice (e.g., curr_RefList0 520) in a known manner.

### CONCLUSION

The above-described scheme may avoid extensive MB level operations by using a table lookup from the slice-MB relation list (i.e., lowest_list0[slice_k] and/or lowest_list1[slice_k]), produced at slice layer, to work out the reference index (i.e., refIdxL0) of every MB for the temporal direct mode of H.264 video codec. The time occupied by the table look-up operation is minimal, and we the number of table look-ups per SubMB is limited to only 1 table look-up per SubMB. Also, the amount of storage at MB level to support such a slice-based scheme is relatively low. The additional per-MB overhead of data format 300 is outweighed by the computations and time saved in calculating lowest_list0[slice_k] and/or lowest_list1[slice_k] at the slice level and then performing look-ups at the MB level.

By contrast with the inventive scheme described above, the reference software (i.e., the so-called Joint Model (JM)) from the H.264 standard that was chosen as an example implementation of H.264 decoding, performs differently. The JM utilizes only MB level operations to accomplish MapColToList0, which require a series of comparisons to work out the lowest valued reference index for each and every MB. Because the number of MBs per picture is large compared to the number of slices per picture, the above-described inventive scheme's reduction of MB-level operations relative to the more conventional JM reference software, may lead to a large savings in operations per picture over the JM reference software.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, although the above scheme has been described for H.264 video decoding, it may also apply to other video standards, such as VC1 and/or H.264.A3, relating to joint scalable video coding (JSVC). The above-described scheme is intended to cover any similar video decoding scheme that uses slice-level processing to reduce MB-level processing for a (temporal) direct decoding mode.

Further, at least some of the acts in FIGS. 4 and 6 may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method of decoding a slice of video data, comprising:
determining two slice reference lists that are associated with the slice of video data;
finding a co-located picture that is associated with the slice of video data;
retrieving two co-located reference lists that are associated with the co-located picture; and
calculating two lowest lists for the slice of video data by comparing pairs of the two slice reference lists and the two co-located reference lists.

2. The method of claim 1, wherein the finding includes:
choosing a first picture in one of the two slice reference lists as the co-located picture.

3. The method of claim 1, wherein the calculating includes:
determining for each element in the two co-located reference lists, a lowest position of an equal element in the two slice reference lists.

4. The method of claim 1, further comprising:
decoding all macroblocks in the slice after the calculating.

5. The method of claim 4, wherein the decoding includes:
decoding macroblocks that are in a direct mode or in a skipped mode using values from the two lowest lists.

6. A method of decoding a slice of video data, comprising:
determining a first reference list associated with the slice of video data;
retrieving a second reference list associated with a co-located picture that is associated with the slice of video data;
calculating a third list including lowest-valued indices from the first reference list of identical items in the first and second reference lists;
determining whether a macroblock in the slice is in a temporal direct mode; and
deriving an index to the first reference list for the macroblock from the third list if the macroblock is in the temporal direct mode.

7. The method of claim 6, wherein the retrieving includes:
choosing a first picture in the first reference list as the co-located picture.

8. The method of claim 6, wherein the deriving includes:
determining a co-located macroblock from the co-located picture that corresponds to the macroblock in the temporal direct mode, and obtaining a co-located reference index from the co-located macroblock.

9. The method of claim 8, wherein the deriving further includes:
inputting the co-located reference index into the third list to obtain the index to the first reference list.

10. The method of claim 6, further comprising:
decoding the macroblock based on the index to the first reference list.

11. An apparatus to decode a slice of video data, comprising:
a memory to store a slice reference list associated with the slice of video data;
means for reading a co-located picture from the slice reference list;
means for retrieving a co-located reference list that is associated with the co-located picture; and
means for calculating a lowest list for the slice of video data by comparing the slice reference list and the co-located reference list.

12. The apparatus of claim 11, wherein the means for calculating includes:
means for determining for each element in the co-located reference list, a lowest position of an equal element in the slice reference list.

13. The apparatus of claim 11, further comprising:
means for decoding macroblocks that are in a direct mode or in a skipped mode using values from the lowest list.

14. A computer-readable medium including a data structure associated with a macroblock of video data thereon, the data structure comprising:
a number that indicates which slice within a picture includes the macroblock;
a first indicator that specifies which one of a first reference list and a second reference list for the slice is associated with a first sub-macroblock within the macroblock;
first index values for the first sub-macroblock into the one of the first reference list and the second reference list specified by the first indicator;
a second indicator that specifies which one of a first reference list and a second reference list for the slice is associated with a second sub-macroblock within the macroblock; and
second index values for the second sub-macroblock into the one of the first reference list and the second reference list specified by the second indicator.

15. The computer-readable medium of claim 14, the data structure further comprising:
a third indicator that specifies which one of a first reference list and a second reference list for the slice is associated with a third sub-macroblock within the macroblock;
third index values for the third sub-macroblock into the one of the first reference list and the second reference list specified by the third indicator;
a fourth indicator that specifies which one of a first reference list and a second reference list for the slice is associated with a fourth sub-macroblock within the macroblock; and
fourth index values for the fourth sub-macroblock into the one of the first reference list and the second reference list specified by the fourth indicator.

16. A method of decoding a picture including a macroblock, comprising:
determining a co-located macroblock for a target macroblock;
determining a slice associated with the co-located macroblock;
specifying which one of a first lowest list and a second lowest list for the slice that a first sub-macroblock within the co-located macroblock is associated with; and
looking up a first reference index in the specified one of the first lowest list and the second lowest list using a first index value associated with the first sub-macroblock.

17. The method of claim 16, further comprising:
specifying which one of a first lowest list and a second lowest list for the slice that a second sub-macroblock within the co-located macroblock is associated with; and
looking up a second reference index in the specified one of the first lowest list and the second lowest list using a second index value associated with the second sub-macroblock.
